(19) United States
(12) Patent Application Publication
(10) Pub. No.: US 2014/0269215 A1
(43) Pub. Date: Sep. 18, 2014

(54) CHAIR TIMER

(71) Applicants: Jorge Carlos Almirall, Acworth, GA (US); W. Drayton Avera, Suwanee, GA (US); Robert Preston Wilson, Covington, GA (US)

(72) Inventors: Jorge Carlos Almirall, Acworth, GA (US); W. Drayton Avera, Suwanee, GA (US); Robert Preston Wilson, Covington, GA (US)

(21) Appl. No.: 14/214,978

(22) Filed: Mar. 16, 2014

Related U.S. Application Data
(60) Provisional application No. 61/786,906, filed on Mar. 15, 2013.

(51) Int. Cl. G04F 1/00

(52) U.S. Cl. CPC G04F 1/005
USPC 368/9

(57) ABSTRACT

A chair timer is disclosed adapted to aid a user seated in a chair equipped with such a chair timer in the reduction of serious health issues associated with prolonged sitting, and crowd management and/or seating management. In various embodiments associated systems and methods of the chair timer are included. In one embodiment, the chair timer includes a sensor to detect movement, a microcontroller to communicate with one or more sensors and other components of the chair timer, a power supply, a switch to control the time and other settings, an alert device by which the user is altered to the passage of a certain amount of time, and additional user-operable control settings and switches by which the device is controlled, and by which control may be accessed and controlled via a website, smart phone, PDA, or the like, through wired or wireless technologies such as Bluetooth, Zigbee, WiFi, or the like.

### CROSS-REFERENCE TO RELATED APPLICATION(S)

The present non-provisional patent application claims the benefit of priority of U.S. Provisional Patent Application No. 61/786,906 which is entitled “CHAIR TIMER”, which was filed on Mar. 15, 2013, and which is incorporated in full by reference herein.

### FIELD OF THE INVENTION

The technology described herein relates generally to the fields of timing devices, alert devices, and seating devices. More specifically, this technology relates to a chair timer, or a multiplicity of chair timers, adapted to aid a user of a chair equipped with such chair timer in the reduction of serious health issues associated with prolonged sitting, and associated systems and methods. Furthermore, this technology relates to a chair timer, or a multiplicity of chair timers, adapted to provide crowd management and/or seating management.

### BACKGROUND OF THE INVENTION

Recent health studies show that people who sit for prolonged periods of time are at increased risk of experiencing significant health issues that include high blood pressure, heart disease, kidney disease, diabetes, obesity, metabolic syndrome, and Deep Vein Thrombosis (DVT). In 2013 alone, there were a large number of news articles covering multiple medical studies about these health risks. A sampling of the article titles gives a glimpse at how bad medical professionals believe sitting for hours at a time can be for a person: “Sit More, And You're More Likely To Be Disabled After Age 60”, “Sitting is the New Smoking—Even for Runners”, “Sitting All Day Is Worse For You Than You Think”, “Failing To Get Off The Couch May Contribute To Heart Failure”, “7 Ways Sitting Will Kill You”, and many more with equally dire titles. According to U.S. Department of Health & Human Services, “Recent research findings are revealing that sitting too much during the day can be detrimental to an individual's health regardless of whether or not they meet the physical activity guidelines for Americans.” (See http://www.health.gov/paguidelines/blog/post/Decreasing-Sedentary-Behavior-and-Physical-Inactivity-by-Moving-More-and-Sitting-Less.aspx)

The recommendations for people who have to sit a lot is to take frequent breaks from sitting down. According to the WebMD.com article “Sitting for Too Long Is Bad for Your Health” (See http://www.webmd.com/heart-disease/news/20110112/sitting-down-too-long-bad-health), “The study, published online in the European Heart Journal, examined the total length of time people spent sitting down and breaks taken in that time, together with various indicators of risk for heart disease, metabolic disease such as diabetes, and inflammatory processes that can play a role in the blocking of arteries. It suggests that plenty of breaks, even if they are as short as one minute, seem to be beneficial.” Other articles give health professional recommendations of taking ten to fifteen minute breaks from sitting, by stretching and walking every hour or so.

Deep Vein Thrombosis (DVT) is a serious medical condition that involves the creation of blood clots in the body that can break off and result in stroke or severe pulmonary blockage. DVT typically occurs in people who are sedentary for a prolonged period of time. In particular, this condition can affect the legs of a person that remains seated for a prolonged period of time. By way of example, DVT may occur for an individual without exercise or movement, such as one on a long airline flight or on one seated at a desk for prolonged period of time. Periodic breaks and walking around stimulates blood flow in the legs and helps prevent DVT.

According to the Centers for Disease Control and Prevention (CDC), “Deep Vein Thrombosis (DVT) and Pulmonary Embolism (PE) are a major public health problem in the United States. Estimates suggest that 350,000 to 600,000 Americans have a DVT or PE each year, and that at least 100,000 people die as a result. Many of those who have a DVT or PE also have complications that can greatly impact their quality of life.” One of the CDC's suggestions to protect oneself is “When sitting for long periods of time, such as when traveling for more than four hours: Get up and walk around every 2 to 3 hours.”

In several countries, there have been reports of sedentary workers, such as those who spend long hours at a desk on a computer, developing DVT. As computer desk work becomes more integral to modern life, DVT could become a growing occupational health concern.

Additionally, and related to persons who sit for a prolonged period of time, and further stare into a screen, such as a computer screen, television, screen, or the like, may experience severe eye strain. The CDC recommends that you look away from the computer screen for at least 20 seconds every 20 minutes in order to prevent eye strain.

Related utility patents known in the background art include the following listed patents:

U.S. Pat. No. 7,614,699, issued to Torres, et al. on Nov. 10, 2009, discloses an automatically controlled therapeutically shifting wheelchair seat.

U.S. Pat. No. 7,399,034, issued to Fullmer, et al. on Jul. 15, 2008, discloses a time-out seat with changeable audio signal.

U.S. Pat. No. 4,538,142, issued to Hamilton, et al. on Aug. 27, 1985, discloses a signal seat for children.

U.S. Pat. No. 5,683,137, issued to McDonald, et al. on Nov. 4, 1997, discloses a time-out chair/seat.

U.S. Pat. No. 7,246,850 issued to Steele on Jul. 24, 2007, discloses a seat weight sensor.

U.S. Pat. No. 7,178,870, issued to Wolfe, et al. on Feb. 20, 2007, discloses seat load sensing apparatus.

U.S. Pat. No. 7,032,968, issued to Sakai, et al. on Apr. 25, 2006, discloses an occupant judging device for a vehicle seat.

U.S. Pat. No. 6,977,592, issued to Orlewski on Dec. 20, 2005, discloses a device for detecting passengers of a vehicle.

U.S. Pat. No. 7,598,881, issued to Morgan on Oct. 6, 2009, discloses a sensor and circuit configuration for occupant detection.

Related published utility patent applications known in the art include the following listed published patent applications:

U.S. Patent Application Publication No. 2006/0033370, filed by Jonas and published on Feb. 16, 2006, discloses an adjustable chair, in particular to prevent users from deep vein thrombosis (DVT).

The foregoing patent and other information reflect the state of the art of which the inventor is aware and are tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

In various exemplary embodiments, the technology described herein provides a chair timer, or a multiplicity of chair timers, adapted to aid a user seated in a chair equipped with such chair timer in the reduction of serious health issues associated with prolonged sitting, and associated systems and methods. The technology described herein also provides a chair timer, or a multiplicity of chair timers, adapted to provide crowd management and/or seating management.

In at least one exemplary embodiment, the technology described herein provides a chair timer adapted to aid a user seated in a chair equipped with such chair timer in the reduction of serious health issues associated with prolonged sitting. The chair timer is a device that helps reduce these serious health risks by providing a timer to remind people seated on a chair, and in particular office chairs, and so forth, that they should get up and walk around. The chair timer is adapted to work with a multiplicity of chair types and configurations. By way of example, and not of limitation, the chair timer can be mounted to an underside of a chair, mounted within a piston, disposed within a chair pad and/or cushion, and so forth.

In various embodiments, the chair timer is adapted for use as a stand-alone unit, embedded with a chair, or embedded with a chair cushion, or the like.

In at least one embodiment, the chair timer is adapted to be calibrated before use to ensure its accuracy.

The chair timer is adapted to detect when a person sits on the chair. Upon detection a timer is started. The user selects the timer duration from a few pre-selected settings or an optional automatic setting that sets the time based on one or more complex algorithms. Once the timer counts the selected time, the user is notified by various means (visual, sound or vibration, or via mobile message, and so forth, for example). The goal of the chair timer is to signal to the user that it is time to take a break and stand up from the chair and walk around. The chair timer senses when the user exits the chair and would wait until the user sits again to start the process all over. In varied embodiments, the chair timer may or may not be configured to tell the user he or she may return.

In at least one embodiment of the chair timer, some one or more algorithms used for control and timing with the chair timer may log time of a person seated in the chair and out of it while away from the chair and use that information to calculate appropriate break times. For example, in the event that the user takes too short of a break time, the unit can notify the user with an audible and/or visual alert. This automatic setting could then adapt the break time interval as needed to break up the sedentary durations.

In at least one embodiment of the chair timer, a sensor is utilized. In at least one embodiment of the chair timer, the sensor is an accelerometer or motion sensor, used to detect movement.

In at least one embodiment of the chair timer, the sensor is a thin, flexible pad to sense and detect the presence or absence of the user. In at least one embodiment, the pad is placed and attached to the top of the chair cushion and would detect when a person sits down and stands up from the pressure exerted on the cushion sensor. The pad could incorporate conductive threads or flexible bend sensors such as those from Flexpoint Sensor Systems to provide the presence detection.

In at least one embodiment of the chair timer, the sensor is one or more of optical, flexible printed electronics, ultrasonic, acoustic, capacitive, resistive, mechanical switch (or other mechanical system such as a balance, weight, and so forth), conductive, or thermal sensors. In each case the sensor is adapted to detect the presence of a person in the chair.

In at least one embodiment of the chair timer, a microcontroller is utilized. The microcontroller is adapted as a controller to communicate with one or more sensors and other components of the chair timer.

In at least one embodiment of the chair timer, a power source is utilized. In at least one embodiment of the chair timer, the power source is a battery. In at least one embodiment of the chair timer, the power source is an AC power source. In at least one embodiment of the chair timer, the power source is an alternative energy power source.

In at least one embodiment of the chair timer, a switch is utilized. By way of example, and in at least one embodiment, the switch is adapted for and is utilized to set the count time option. The switch is adapted to actuate the timer and/or the alert device as needed based on the circumstances of use of the chair timer.

In at least one embodiment of the chair timer, an alert device is utilized. By way of example, and in at least one embodiment, the alert device provides a visual alert. In at least one embodiment, a sound alert is provided. It at least one embodiment, a vibratory alert is provided. It at least one embodiment, multiple alerts are provided such that two or more alert queues are provided to the user. In at least one embodiment, alerts include one or more of mobile, text, email, SMS messages, or the like through the use of wireless technologies such as Bluetooth, Zigbee, WiFi or other like technology.

In at least one embodiment of the chair timer, one or more control settings and control switches is utilized. By way of example, and in at least one embodiment, the control setting is a “SNOOZE” button or setting to allow the user to complete an important task or phone call prior to being alerted again. Additional controls such as alert type, loudness, and so forth are configurable with the one or more control settings and control switches dependent on user selection and need.

In at least one embodiment of the chair timer, a printed circuit board is utilized. In at least one embodiment, the above components are adapted for electronic coupling on a backplane, printed circuit board (PCB), or the like. In at least one embodiment, the PCB includes a microcontroller, sensor, switch, and alert device, all of which are electronically coupled and may communicate with one or more other coupled components.

In at least one embodiment of the chair timer, a slide switch and/or sensors is also included to enable a user to communicate with the chair timer through the use of the slide switch or the sensor. The switch and/or sensor includes movement, squeezing, tilting, like sensors.

In at least one exemplary embodiment, the technology described herein provides a chair system having a chair timer coupled with the chair and adapted to aid a user seated in the chair equipped with such chair timer in the reduction of serious health issues associated with prolonged sitting.

The technology described herein also provides a chair system, having one or a multiplicity of chair timers, adapted to provide crowd management and/or seating management. In this chair system embodiment, the chair timer and the chair may be coupled together as a single unit for sale and use. The chair timer and chair may be integrally formed. The chair timer may have any one or more of the alternative configurations, sensors, alert devices, power sources, and so forth, discussed above incorporated with the chair into which it is coupled. In at least one embodiment, the chair timer for crowd management includes the capability to communicate to a supervisory system to provide seating usage status via wired technologies or via Bluetooth, Zigbee, WiFi, or some other wireless technology.

In at least one exemplary embodiment, the technology described herein provides a method for utilizing a chair timer system to aid in the reduction of serious health issues associated with prolonged sitting.

In operation, and by way of example, the chair timer can be utilized by one or more of the following methods steps:
utilizing a chair timer;
monitoring the time in which a user is seated in a chair and/or viewing into a screen;
detecting the presence of a seated user upon a chair equipped with the chair timer;
counting a predetermined amount of time, by user selection, or by predetermined, embedded one or more algorithm, or by adaptive algorithm;
signalizing to the user;
waiting for the user to stand up (or move away from viewing a screen);
inquiring whether a certain predetermined amount of time, or by adaptive algorithm, has passed before the user returns to the chair/screen; and
repeating process steps based upon selected time intervals.

Additional method steps can include:
calibrating the chair timer;
snoozing a time interval setting;
utilizing multiple alerts to signal the user;
utilizing escalating alerts;
utilizing settings for alerts, such as aggressive, typical, and conservative, for example;
utilizing adaptive learning and/or adaptive algorithms; and
utilizing mobile options for control of chair timer such as incorporation by smart phone, PDA, and so forth through the use of wireless technologies such as Bluetooth, Zigbee, WiFi or other like technology.
controlling advanced timer options by the user.

It will be apparent to those skilled in the art, after reading this disclosure, which methods steps disclosed can be performed simultaneously or in a different order than that depicted, or omitted given the nature of a particular procedure.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a flowchart diagram illustrating exemplary method steps by which a chair timer adapted to aid a user of a chair equipped with such chair timer in the reduction of serious health issues associated with prolonged sitting, and crowd management and/or seating management, according to an embodiment of the technology described herein;

FIG. 2 is a schematic diagram illustrating the general components of a chair timer adapted to reduce serious health issues associated with prolonged sitting, and crowd management and/or seating management, illustrating, in particular, a microcontroller, switch, sensor, power source, alert device, control settings and switches, any one or more of which may be used in a chair timer, each of which are electronically coupled via a printed circuit board, or like device, according to an embodiment of the technology described herein; and

FIG. 3 is a schematic diagram illustrating the chair timer device depicted in FIG. 2 in use on a chair as a complete system, and adapted for use according to the method steps depicted in FIG. 1, according to an embodiment of the technology described herein.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

Referring now to the drawing figures, and in various exemplary embodiments, the technology described herein provides a chair timer 200 adapted to aid a user seated in a chair 302 equipped with such chair timer 200 in the reduction of serious health issues associated with prolonged sitting, and crowd management and/or seating management. The technology described herein additionally provides associated systems and methods for use of the chair timer and/or chair timer system for the reduction of serious health issues associated with prolonged sitting.

In at least one exemplary embodiment, the technology described herein provides a chair timer 200 adapted to aid a user seated in a chair 302 equipped with such a chair timer 200 in the reduction of serious health issues associated with prolonged sitting, and crowd management and/or seating management.

The chair timer 200 is a device that helps reduce the risk of serious health issues associated with prolonged sitting, and crowd management and/or seating management by providing a timer to remind a person seated on a chair 302, and in particular an office or desk chair, or the like, that he or she should get up and walk around, thus to conduct an effort to help reduce the risk of serious health issues associated with prolonged sitting by essentially stimulating or reminding a user to take time away from the seated position in the chair and visual attention away from a screen, such as a television screen, computer display screen, or the like.

The chair timer 200 is adapted to work with a multiplicity of chair types and configurations. By way of example, and not of limitation, the chair timer 200 can be mounted to an underside of a chair 302, mounted within a piston, disposed within a chair pad, and so forth.

In various embodiments, the chair timer 200 is adapted for use as a stand-alone unit as noted above, embedded within a chair, or embedded within a chair cushion, or the like. Additionally, the components of the chair timer 200 depicted in FIG. 2, can vary. One or more disclosed elements of FIG. 2 are included in the chair timer 200; however, not all elements are required in all embodiments. By way of example, a timer or analog integrator can be used instead of a microcontroller.

In at least one embodiment, the chair timer 200 is adapted to be calibrated before use to ensure its accuracy. Calibration of the chair timer 200 will ensure that time and distance, weight, pressure, or alignment is measured correctly, and other settings and parameters are utilized and measured properly. This ensures proper detection of seating and/or unseating.

The chair timer 200 is adapted to detect when a person sits on the chair 302. Upon detection a timer is started. The user selects the timer duration from a few pre-selected settings or an optional automatic setting that sets the time based on a more complex algorithm, embedded within the chair timer 200. Once the timer counts the selected time, the user is notified by various means (visual, sound or vibration, for example) by an alert device 212. An objective of the chair timer 200 is to signal to the user that it is time to take a break and stand up from the chair 302 and walk around. The chair timer 200 senses when the user exits the chair 302. The chair timer 200 then passively waits until the user sits again upon the chair 302 to start the process all over. Upon detection by the sensor 206, the chair timer process steps 100 will commence as depicted between methods steps 110 and 102. In at least one embodiment, the chair timer 200 is adapted to notify when it is safe or appropriate to return to a seated position. Such indication is a red/green/yellow type light signal in one embodiment. In at least one embodiment, a warning or indicator is provided when the time is getting close.

In at least one embodiment of the chair timer 200, some algorithms used for control and timing with the chair timer 200 may log time of a person seated in the chair 302, and also out of it while away from the chair 302, and use that information to calculate appropriate break times, or report to a monitoring system for logging and tracking. For example, in the event that the user takes too short of a break time, the unit can notify the user with an audible and/or visual alert. This automatic setting could then adapt the break time interval as needed to break up the sedentary durations.

In at least one embodiment of the chair timer 200, a sensor 206 is utilized. In at least one embodiment of the chair timer 200, the sensor 206 is an accelerometer or motion sensor, used to detect movement.

In at least one embodiment of the chair timer 200, the sensor 206 is a thin, flexible pad, including, for example, conductive threads and/or an insulation layer, adapted to sense and detect either the presence or absence of the user. In at least one embodiment, the pad is placed and attached to the top of the chair cushion and is configured to detect when a person sits down and also stands up based on the measured pressure exerted on the cushion sensor. In at least one embodiment, the pad could incorporate conductive threads or flexible bend or pressure sensors such those from Flexpoint Sensor Systems to provide the presence detection.

In at least one embodiment of the chair timer 200, the sensor 206 is one or more of optical, flexible printed electronics, ultrasonic, acoustic, capacitive, resistive, mechanical switch, mechanical conductive, or thermal sensors. In each case the sensor 206 is adapted to detect the presence of a person in the chair 302. More than one sensor 206 type may be utilized in various embodiments and combinations of use of the chair timer 200.

In at least one embodiment of the chair timer, a microcontroller 202 is utilized. The microcontroller 202 is adapted as a controller to communicate with one or more sensors 206 and other components of the chair timer 200. The microcontroller 202 is adapted to control the various time measurements activities. Additionally, in at least one embodiment of the chair timer, a timing circuit is utilized. The timing circuit is configured to keep track of time and can be used in conjunction with the microcontroller.

In at least one embodiment of the chair timer 200, a power source 210 is utilized. In at least one embodiment of the chair timer 200, the power source 210 is a battery. In at least one embodiment of the chair timer 200, the power source 210 is an AC power source. In at least one embodiment of the chair timer 200, the power source 210 is an alternative energy power source.

In at least one embodiment of the chair timer 200, a switch 204 is utilized. By way of example, and in at least one embodiment, the switch 204 is adapted for and is utilized to set the count time option. The switch 204 is adapted to actuate the timer and/or the alert device as needed based on the circumstances of use of the chair timer 200. The switch 204 can be user-operable in at least one embodiment, and algorithm controlled in at least one alternative embodiment.

In at least one embodiment of the chair timer 200, an alert device 212 is utilized. By way of example, and in at least one embodiment, the alert device 212 provides a visual alert. In at least one embodiment, a sound alert is provided by the alert device 212. It at least one embodiment, a vibratory alert is provided by the alert device 212. It at least one embodiment, multiple alerts are provided by the alert device 212 such that two or more alert queues are provided to the user.

In at least one embodiment of the chair timer 200, one or more control settings and control switches 214 is utilized. By way of example, and in at least one embodiment, the control setting is a “SNOOZE” button or setting to allow the user to complete an important task or phone call prior to being alerted again. Additional controls such as alert type, loudness, and so forth are configurable with the one or more control settings and control switches dependent on user selection and need. In at least one embodiment, such monitoring is conducted via a website and/or a mobile phone, smart phone, PDA, or the like. As such the chair timer 200 provides usage information and can accumulate chair usage and provide the capability to download the data to a computer, smart phone or other portable electronic device. The chair timer 200 can also upload usage data to the internet via wired or wireless communication such as Wi-Fi, Bluetooth, Zigbee or other formats. In at least one embodiment, the chair timer 200 for crowd management includes the capability to communicate to a supervisory system to provide seating usage status via Bluetooth, Zigbee, WiFi, or some other wireless technology. Wired or wireless communication utilizing Wi-Fi, Bluetooth, Zigbee or other formats is completed with communication device 216.

In at least one embodiment of the chair timer 200, a printed circuit board 208 is utilized. In at least one embodiment, the above components are adapted for electronic coupling on a backplane, printed circuit board (PCB) 208, or the like. In at least one embodiment, the PCB 208 includes a microcontroller 202, sensor 206, switch 204, and alert device 212, all of which are electronically coupled and may communicate with one or more other coupled components.

In at least one exemplary embodiment, the technology described herein provides a chair system 300 having a chair timer 200 coupled with the chair 302 and adapted to aid a user seated in the chair 302 equipped with such chair timer 200 in the reduction of serious health issues associated with prolonged sitting. In this chair system 300 embodiment, the chair timer 200 and the chair 302 are coupled together as a single unit for sale and use. The chair timer 200 and chair 302 may be integrally formed. The chair timer 200 may have any one or more of the alternative configurations, sensors 206, alert devices 212, power sources 210, and so forth, discussed above incorporated with the chair 302 into which it is coupled. Additionally, the chair timer 200 is used for crowd management and/or seating management.

In at least one exemplary embodiment, the technology described herein provides a method 100 for utilizing a chair timer 200 or chair timer system 300 to aid in the reduction of serious health issues associated with prolonged sitting, and crowd management and/or seating management.

In operation, and by way of example, the chair timer can be utilized by one or more of the following methods steps:
utilizing a chair timer 200;
monitoring, such as in method step 102, the time in which a user is seated in a chair and/or viewing into a screen;
detecting the presence of a seated user upon a chair equipped with the chair timer;
counting, such as in method step 104, a predetermined or variable amount of time, by user selection, or by predetermined, embedded algorithm;
signalizing, such as in method step 106, to the user;
waiting, such as in method step 108, for the user to stand up (or move away from viewing a screen);
inquiring, such as in method step 110, whether a certain predetermined amount of time has passed before the user returns to the chair/screen; and
repeating process steps based upon selected, or autonomously created, time intervals.

Additional method steps can include:
calibrating the chair timer;
snoozing a time interval setting;
utilizing multiple alerts to signal the user;
utilizing escalating alerts;
utilizing settings for alerts, such as aggressive, typical, and conservative, for example; and
controlling advanced timer options by the user, and/or by autonomous or adaptive operation.

It will be apparent to those skilled in the art, after reading this disclosure, which methods steps disclosed can be performed simultaneously or in a different order than that depicted, or omitted given the nature of a particular procedure.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A chair timer, to aid a user seated in a chair equipped with such chair timer in the reduction of serious health issues associated with prolonged sitting, the chair timer comprising:
a sensor to detect when a person sits on the chair and to detect when the person gets up out of the chair;
an alert device to communicate a signal to the user seated in the chair that it is time to take a break and stand up from the chair and walk around; and
a timer to countdown a predetermined period to time and to actuate the alert device.

2. The chair timer of claim 1, wherein the sensor to detect when a person sits on the chair and to detect when the person gets up out of the chair is an accelerometer.

3. The chair timer of claim 1, wherein the sensor to detect when a person sits on the chair and to detect when the person gets up out of the chair is a motion sensor.

4. The chair timer of claim 1, wherein the sensor to detect when a person sits on the chair and to detect when the person gets up out of the chair is an infrared (IR) sensor.

5. The chair timer of claim 1, wherein the sensor to detect when a person sits on the chair and to detect when the person gets up out of the chair is a switch.

6. The chair timer of claim 1, wherein the sensor to detect when a person sits on the chair and to detect when the person gets up out of the chair is a thin, flexible pad to sense and detect the presence or absence of the user.

7. The chair timer of claim 1, wherein the alert device is a visual indicator device, and wherein the signal communicated by the alert device is a visual indicator signal, to visually communicate to the user that it is time to take a break and stand up from the chair and walk around.

8. The chair timer of claim 1, wherein the alert device is an audio indicator device, and wherein the signal communicated by the alert device is an audio indicator signal, to audibly communicate to the user that it is time to take a break and stand up from the chair and walk around.

9. The chair timer of claim 1, wherein the alert device is a vibrating device, and wherein the signal communicated by the alert device is a vibrating indicator signal, to vibratingly communicate to the user that it is time to take a break and stand up from the chair and walk around.

10. The chair timer of claim 1, wherein the alert device is a device to receive electronic communication messages, and wherein the signal communicated by the alert device is one of a mobile messaging signal, a non-mobile wireless signal, and a wired system signal, to indicate by instant message, text message, mobile message, or other message to communicate to the user that it is time to take a break and stand up from the chair and walk around.

11. The chair timer of claim 1, further comprising:
at least one additional sensor.

12. The chair timer of claim 1, further comprising:
a microcontroller to communicate with one or more sensors, the alert device, and the timer.

13. The chair timer of claim 1, further comprising:
a power source to provide power to the chair timer device.

14. The chair timer of claim 1, further comprising:
a switch to set the count time option and to actuate the timer and/or the alert device as needed based on the circumstances of use of the chair timer.

15. The chair timer of claim 1, further comprising:
an algorithm to set time settings for the timer.

16. The chair timer of claim 1, further comprising:
at least one control setting to set an chair timer function.

17. A combined chair and chair timer to aid a user seated in a chair equipped with such chair timer in the reduction of serious health issues associated with prolonged sitting, the combined chair and chair timer comprising:
a chair; and
a chair timer device comprising:
a sensor to detect when a person sits on the chair and to detect when the person gets up out of the chair;
an alert device to communicate a signal to the user seated in the chair that it is time to take a break and stand up from the chair and walk around; and
a timer to countdown a predetermined period to time and to actuate the alert device.

18. The combined chair and chair timer of claim 17, further comprising:
at least one additional chair timer device to electronically pair with the chair.

19. A method for utilizing a chair timer system to aid in the reduction of serious health issues associated with prolonged sitting, the method comprising:
utilizing a chair timer device comprising:
a sensor to detect when a person sits on the chair and to detect when the person gets up out of the chair;
an alert device to communicate a signal to the user seated in the chair that it is time to take a break and stand up from the chair and walk around; and
a timer to countdown a predetermined period to time and to actuate the alert device;
monitoring the time in which a user is seated in a chair and/or viewing into a screen;
detecting the presence of a seated user upon a chair equipped with the chair timer;
counting a predetermined amount of time, by user selection, or by predetermined, embedded one or more algorithm, or by adaptive algorithm;
signalizing to the user;
waiting for the user to stand up (or move away from viewing a screen);
inquiring whether a certain predetermined amount of time, or by adaptive algorithm, has passed before the user returns to the chair/screen; and
repeating process steps based upon selected time intervals.

20. The method of claim 19, further comprising:
calibrating the chair timer;
snoozing a time interval setting;
utilizing multiple alerts to signal the user;
utilizing escalating alerts;
utilizing settings for alerts;
utilizing adaptive algorithms;
utilizing mobile options for control of the chair timer; and
controlling advanced timer options by the user.

21. The method of claim 19, further comprising:
utilizing one or more of the chair timer device in a seat management configuration; and
communicating to a supervisory system seating usage status via an electronic communications means.
